(19) United States
(12) Patent Application Publication
(10) Pub. No.: US 2008/0117215 A1
(43) Pub. Date: May 22, 2008

(54) Providing A Model With Surface Features

(75) Inventor: Christophe Hery, San Rafael, CA (US)

Correspondence Address: FISH & RICHARDSON, PC, P.O. BOX 1022, MINNEAPOLIS, MN, 55440-1022, US

(73) Assignee: LUCASFILM ENTERTAINMENT COMPANY LTD, San Francisco, CA (US)

(21) Appl. No.: 11/561,848

(22) Filed: Nov. 20, 2006

(51) Int. Cl. G06T 13/00

(52) U.S. Cl. 345/473

(57) ABSTRACT

A computer-implemented method for providing a model with surface features includes obtaining first and second models of an object. The first model has a first-model resolution that is higher than a resolution of the second model and including surface features. The second model is generated independently of the first model. The method includes generating a version of the first model that has a lower resolution than the first-model resolution. The method includes determining a difference between the second model and the version of the first model. The method includes modifying the second model to include the surface features, wherein the modification includes compensating for the determined difference.

### TECHNICAL FIELD

This document relates to image generation.

### BACKGROUND

The process of generating an animation often involves the use of one or more models for the included character(s). The model can be configured during the animation process to assume different positions and/or appearances, all to satisfy the requirements of the particular animation being generated. When the animation is ready, it can be processed in a rendering stage to produce the individual frames that are to be assembled into the final animated feature, such as a motion picture.

Sometimes, the model used at the animation and rendering stages has a lower resolution than what is desired to obtain in the final image. This can avoid the issues with performance in the animation system that could otherwise occur if one attempted to carry out the animation using a model of very high (or “picture quality”) resolution. Rather, it has been found preferable in some circumstances to try to add fine details and other features to the model later, such as when the animation and rendering is complete. One approach that has been used for this purpose is to manually paint a bump or displacement texture map which is then applied to the lower-resolution model in the final image generation. However, the process of manually generating the texture map can be very labor intensive and prone to errors.

### SUMMARY

In a first general aspect, a computer-implemented method for providing a model with surface features includes obtaining first and second models of an object. The first model has a first-model resolution that is higher than a resolution of the second model and including surface features. The second model is generated independently of the first model. The method includes generating a version of the first model that has a lower resolution than the first-model resolution. The method includes determining a difference between the second model and the version of the first model. The method includes modifying the second model to include the surface features, wherein the modification includes compensating for the determined difference.

Implementations can include all, some or none of the following features. The object can be a character in an animation. The object can be a non-character feature in an animation. The first model can be obtained by scanning a physical object, and the surface features in the first model can correspond to physical surface features on the physical object. The version of the first model can be generated at about the same resolution as the second model. When an original version of the second model has a different positional configuration than the first model, the method can further include reconfiguring the original version of the second model into the second model before the difference is determined, wherein the reconfiguration seeks to eliminate the different positional configuration. Determining the difference can include performing a raytracing performed between the second model and the version of the first model. The compensation can include subtracting the difference from a raytracing performed between the first model and the second model. Determining the difference can include performing a raytracing performed between the second model and the version of the first model. The modification of the second model can be performed as part of a rendering operation following an animation. Modifying the second model can include applying a texture map corresponding to the surface features, and the compensation can be done in generating the texture map. The method can further include repeating the generating step to generate multiple versions of the first model at different resolutions, and using the multiple versions to generate multiple texture maps. At least one of the texture maps can be used in the compensation for a specific portion of the second model, and at least another one of the texture maps can be used in the compensation for another specific portion of the second model. The second model can include a hierarchy of features, and the specific portion and the other specific portion can be at different levels of detail in the hierarchy.

Implementations can provide all, some or none of the following advantages: Providing an improved use of models in image generation; providing an improved error correction when applying surface features to an independently created model; providing reduction or elimination of the influence of differences between a higher-resolution model and a lower-resolution model when the former is used to provide surface features for the latter; providing an improved error correction in raytracing.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram showing an example of a computer graphic animation and rendering system.

FIG. 2 shows examples of animation models of different resolutions and facial expressions.

FIGS. 3A-C show an example of adding surface features to a model.

FIG. 4 is a flowchart showing an example of a method for providing a model with surface features.

FIG. 5 is a block diagram of a computing system that can be used in connection with computer-implemented methods described in this document.

Like reference symbols in the various drawings indicate like elements.

### DETAILED DESCRIPTION

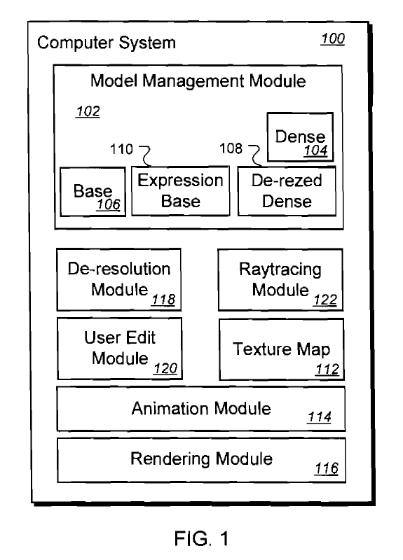

FIG. 1 shows an example of a computer system 100 that is capable of generating computer graphics using geometry models. The system 100 includes a model management module 102. The model management module 102 can work with many types of, and any number of, models, including those shown in this example: dense model 104 and a base model 106. The dense model 104 may be a higher resolution model that includes realistic surface features of a modeled object. The base model 106 may be a lower resolution model that is generated independently of the dense model 104 for animation purposes. The model management module 102 can also handle a de-rezed dense model 108 and an expression base model 110 that can be generated from the dense model 104 and the base model, respectively. For example, the computer system 100 can generate a texture map 112 to be used in modifying the base model 106 to include surface features that are obtained from the dense model 104.

The computer system 100 includes an animation module 114 for generating animated screens. As part of the animation process, the animation module 114 may use the base model 106 to generate animated screens that include the base model 106. One or more models can be used in the animation depending on the number of characters involved in the scene. In individual ones of such screens the base model can be configured to have, for example, different facial expressions or body poses as required by the director.

The computer system 100 includes a rendering module 116 for rendering frames from the animated screens. For example, the rendering module 116 may use the base model 106 and generate frames to include additional details, such as lighting effects and surface features. In the depicted example, the model management module 102 may apply the texture map 112 to the base model 104 such that the rendering module 116 can generate the frames with detailed and realistic surface features. In one example, the texture map 112 may be a bump or displacement map that maps surface textures of a modeled object (e.g., a face) to a surface of the base model 106.

The model management module 102 can be used in modeling the object (e.g., a character in the animation or part thereof, such as a human face). For example, the model management module 102 may generate the base model 106 to model a human face using modeling software. In some implementations, the modeled human face may show the face with muscles relaxed and a normal expression, such as with the eyes open. The dense model 104 can be generated by scanning (e.g., using a high resolution laser scanning technique) a mask that has been molded on a person's face. Thus, the physical surface features of the person's face can be reproduced in the dense model. For example, the dense model 104 generated from the mask may include fine contours of the face, such as skin pores, winkles, or other topical characteristics.

In some examples, the base model 106 may have a different positional configuration, such as a different facial expression, than the dense model 104. For example, this can be because the base model 106 is preferred to have a certain expression during the animation (such as with the eyes open) for esthetical and other reasons, while the dense model 104 has the eyes shut due to the process of molding a mask on a living person's face. Thus the presence of surface features (such as wrinkles or skin pores) is not the only difference in the geometry of the two models 104, 106. Rather, there can also be differences resulting from the ways in which the models 104, 106 were independently created. In some examples the computer system 100 may compensate for this in generating the texture map 112, for example by excluding one or more differences between the two models 104, 106 due to the differing facial expressions.

In the depicted example, the computer system 100 includes a de-resolution module 118 and a user edit module 120. The model management module 102 may use the de-resolution module 118 to generate the de-rezed dense model 108. For example, the de-rezed dense model 108 can be generated by reducing the resolution of the dense model 104 to roughly the same resolution of the base model 106.

Using the user edit module 120, a user may also modify the base model 106 to generate the expression base model 110 to have the facial expression resembling that of the dense model 104 or of the de-rezed dense model 108. For example, the user edit module 120 may receive user inputs to modify the facial expression of the base model 106 to generate the expression base model 110. By reconfiguring the facial expression of the base model 106, the difference in positional configuration between the models 104, 106 can be reduced or eliminated.

The computer system 100 also includes a raytracing module 122 to provide precise mapping of points (e.g., vertices) on separate models to each other. For example, the raytracing module 122 may perform raytracing operations to determine differences between the models 104, 106. For example, the raytracing module 122 may cast multiple imaginary rays to obtain a quantified measurement of the difference between two surfaces. In some examples, the raytracing module 122 may obtain the surface difference between the dense model 104 and the expression base model 110. However, as noted above, such an obtained difference may reflect not only the presence of surface features in the dense model 104 (and, likewise, the absence of those features in the base model 106), but may also reflect the difference in shape between the models 104, 106, such as the remaining difference in facial expressions between the dense model 104 and the expression base model 110.

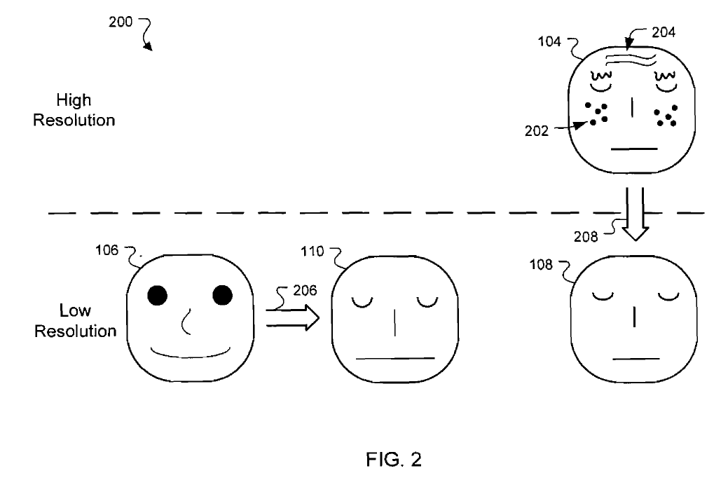

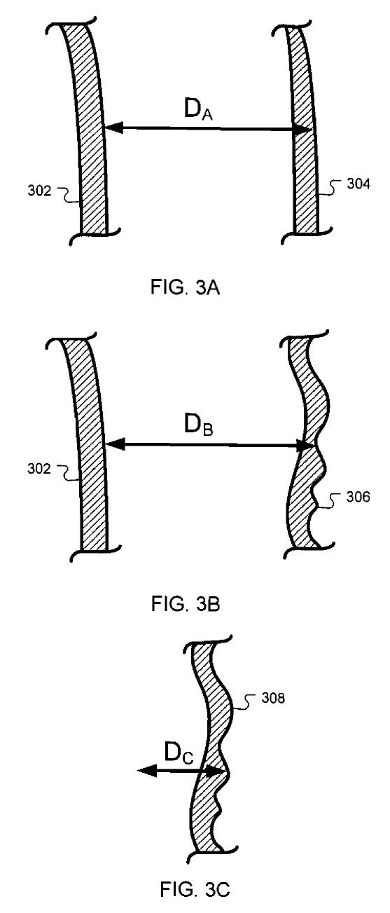

The computer system 100 may compensate for some or all of the errors by determining an error correction term and generating the texture map 112 using both the obtained difference and the error correction term. Some examples of methods to accurately generate the texture map 112 are described below in FIGS. 2-3C.

In the above example, the texture map was applied to an animate object, i.e., a character in the animation. This is not the only animation feature to which texture maps can be applied. They can also be applied to inanimate objects, for example to restore surface details in an architectural piece that is to be included in the animation. Thus, the texture map can be applied to a non-character object, as another example.

FIG. 2 schematically shows an example of using the models 104, 106, 108, 110 in a resolution space 200. In the depicted example, the models 104, 106, 108, 110 are models of a human face. For example, the models 104, 106, 108, 110 may be used to generate frames of a character's face in an animation. In other implementations, the models can represent other features, human or non-human.

Here, the base model is generated at a relatively low resolution. In contrast, the dense model 104 is generated at a relatively high resolution. In some implementations, the dense model 104 and the base model 106 may both be a face of a character that is part of an animation. Because the dense model 104 is generated by scanning the person's face, the dense model 104 includes surface features such as pores 202 and wrinkles 204.

The dense model 104 may have a facial expression that is different than that of the base model 106. To reduce or eliminate the facial expression difference, the base model 106 may be modified to assume or resemble the facial expression of the dense model 104. As indicated by an arrow 206, the expression base model 110 can be generated from the base model 106, for example at a resolution approximately the same as the base model 106. For example, the user may use the user edit module 120 to generate the expression base model 110 by modifying the facial expression of the base model 106 manually. Here, the expression base model 110 may have a facial expression that approximates the facial expression of the dense model 104 (e.g., with the eyes shut and a relaxed expression). In various implementations, the operation indicated by the arrow 206 may reduce or eliminate facial expression difference between the expression base model 110 and the dense model 104.

As indicated by an arrow 208, the de-rezed dense model 108 can be generated based on the dense model 104. For example, the model management module 102 can reduce a resolution of the dense model 104 to generate the de-rezed dense model 108. In some implementations, the de-rezed dense model 108 may have approximately the same resolution as the base model 106. As shown in FIG. 2, the de-rezed dense model 108 may not include the pores 202 and the wrinkles 204 of the dense model 104 depending on the amount of de-resolution. However, the de-rezed dense model 108 may entirely or in part retain the facial expression of the dense model 104. As can be seen by comparing the expression base model 110 and the de-rezed model 108, some differences in shape can remain, such as the difference in facial expressions, between the expression base model 110 and the dense model 104.

In some implementations, the model management module 102 may generate the texture map 112 by mapping, for each uv position on the modeled object, a texture value to the base model 106. In some examples, a set of the texture values can be included in the texture map 112. By adding the texture map 112 to the base model 106 in the animated screens, the rendering module 116 can generate a more photo-realistic frame, such as frames with relatively photo-realistic faces.

To obtain the texture values, the model management module 102 may determine a textural difference between the base model 106 and the dense model 104 while eliminating or reducing the influence of the differences in positional configurations of the two models 104, 106. In some implementations, an error correction term is determined. As an illustrative example, FIGS. 3A-C show an example of a process to obtain, for each uv position, an error correction term (D_{A}), a distance between the dense model 104 and the expression base model 110 (D_{B}), and a texture value (e.g., a displacement value or a bump value) reflecting the surface feature of the modeled object (D_{C}).

As shown in FIG. 3A, D_{A} is determined by obtaining a difference between an expression base model surface 302 and a de-rezed dense model surface 304. The expression base model surface 302 and the de-rezed dense model surface 304 may be surfaces of the expression base model 110 and the de-rezed dense model 108, respectively. In one implementation, the raytracing module 122 can determine D_{A} by casting a ray along the normal from each uv position on the expression base model 110, intersecting the corresponding position on de-rezed dense model surface 304. For example, the length of the ray may be stored as the error correction term D_{A}. This can be repeated for several or all positions on the model, resulting in an array of correction terms.

As shown in FIG. 3B, D_{B} is determined by obtaining a difference between the expression base model surface 302 and a dense model surface 306. The dense model surface 306 may be a surface of the dense model 104. In one implementation, the raytracing module 122 can determine D_{B} by casting a ray along the normal from each uv position on the expression base model 110 intersecting the corresponding position on the dense model surface 306. For example, the length of the ray may be stored as the distance D_{B}. This can be repeated for several or all positions on the model, resulting in an array of differences.

The distance D_{B} and the error correction term D_{A} can be combined to generate the texture value D_{C}. In some examples, the error correction term D_{A} may be used to compensate the positional configuration difference included in the distance D_{B}. In some implementations, the texture value can be calculated as:

D_{C}=D_{B}−D_{A}.

In other implementations, more complex mathematical operations, such as non-linear functions or optimization techniques, may be used to obtain D_{C}.

As shown in FIG. 3C, D_{C} is applied to modify the base model 106 or the expression base model 110. The modification can include compensating the difference between the de-rezed dense model 108 and the expression base model 110. As a result, a modified base model surface 308 may have surface features equal to, or approximating, the surface features of the dense model 104. In some implementations, the difference between the de-rezed dense model 108 and the expression base model 110 may be compensated by subtracting D_{A} from D_{B}.

In some implementations, the modification of the base model 106 may be performed as part of the rendering operation performed by the rendering module 116. For example, the model management module 102 may generate the texture map 112 using D_{C} at a plurality of uv positions. The rendering module 116 can then apply the texture map 112 to add surface features to the base model 106 during the rendering operation.

In some implementations, the model management module 102 can generate multiple texture maps 112 at different resolutions. For example, the de-resolution module 118 may generate several of the de-rezed dense models 108 at more than one resolution. Using the de-rezed dense models 108, the model management module 102 may generate the texture maps 112 corresponding to the different resolutions. In various examples, the resulting texture maps 112 may be used at different levels of details. For example, when the rendering module 116 is generating a frame with a high level of details, the rendering module 116 may use the texture map 112 with a high resolution. In another example, when the rendering module 116 is generating a frame with a low level of details, the rendering module 116 may use the texture map 112 with a low resolution. In some examples, using a lower resolution texture map can have the advantage of reducing rendering time and computation power.

In some implementations, the rendering module 116 may apply different texture maps to different parts of the object. For example, the rendering module 116 may apply gross features using a displacement type texture map to preserve edges. In another example, the rendering module 116 may apply a bump type texture map to a smaller object to preserve computation power.

In some implementations, the different texture maps are applied to features at different levels of a hierarchy. The model can include hierarchically organized features such that a first feature exists at a first level of the hierarchy and a second feature exists at a second level of the hierarchy, with the second level being lower in the hierarchy than the first level. In such an example, a different texture map can be applied to the second feature than to the first feature due to the difference in hierarchy level.

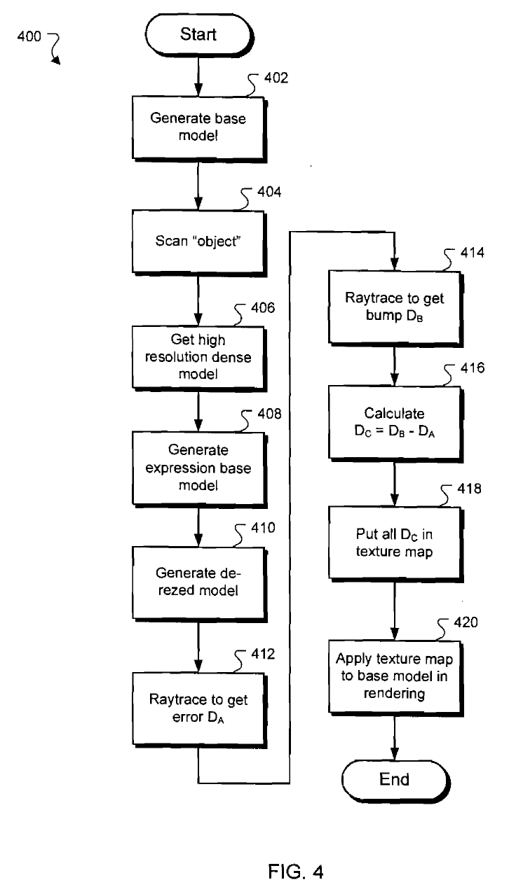

FIG. 4 is a flow chart of exemplary operations 400 that can be performed for providing a model with surface features. The operations 400 can be performed by a processor executing instructions stored in a computer program product. The operations 400 begin in step 402 with generating a base model. For example, the model management module 102 may generate the base model 106 using modeling software. In step 404, the operations 400 comprise scanning an “object.” For example, the computer system 100 may scan a mask that has been molded on a person's face.

Next, the operations 400 comprise, in step 406, getting a high resolution dense model. For example, the model management module 102 may generate the dense model 104 scanning the mask using a high resolution laser scanning technique. As another example, the dense model 104 can be received from a remote scanning service. In step 408, the operations 400 comprise generating an expression base model. For example, the user edit module 120 may generate the expression base model 110 by approximating the facial expression of the dense model 104. The operations 400 comprise generating a de-rezed model in step 410. For example, the de-resolution module 118 may generate the de-rezed dense model 108 by reducing the resolution of the dense model 104.

In step 412, the operations 400 comprise performing raytracing to get error D_{A}. For example, the raytracing module 122 may to determine the differences between the expression base model 110 and the de-rezed dense model 108. In some examples, the differences may represent at least part of the positional difference between the dense model 104 and the expression base model 110. The operations 400 comprise, in step 414, performing raytracing to get the distance or value D_{B}. For example, the raytracing module 122 may determine the differences between the expression base model 110 and the dense model 104 to obtain the distance D_{B}.

Next, the operations 400 comprise calculating DC=D_{B}−D_{A} in step 416. For example, the model management module 102 may generate the texture value for each uv position by compensating the positional configuration difference between the dense model 104 and the expression base model 110 using the equation D_{C}=D_{B}−D_{A}. In step 418, the operations 400 comprise putting all D_{C} in a texture map. For example, the model management module 102 may generate the texture map 112 using D_{C} obtained at the ray casting positions. The operations 400 comprise, in step 420, applying the texture map to the base model in rendering. For example, the rendering module 116 may apply the texture map 112 to the base model 106 during a rendering operation.

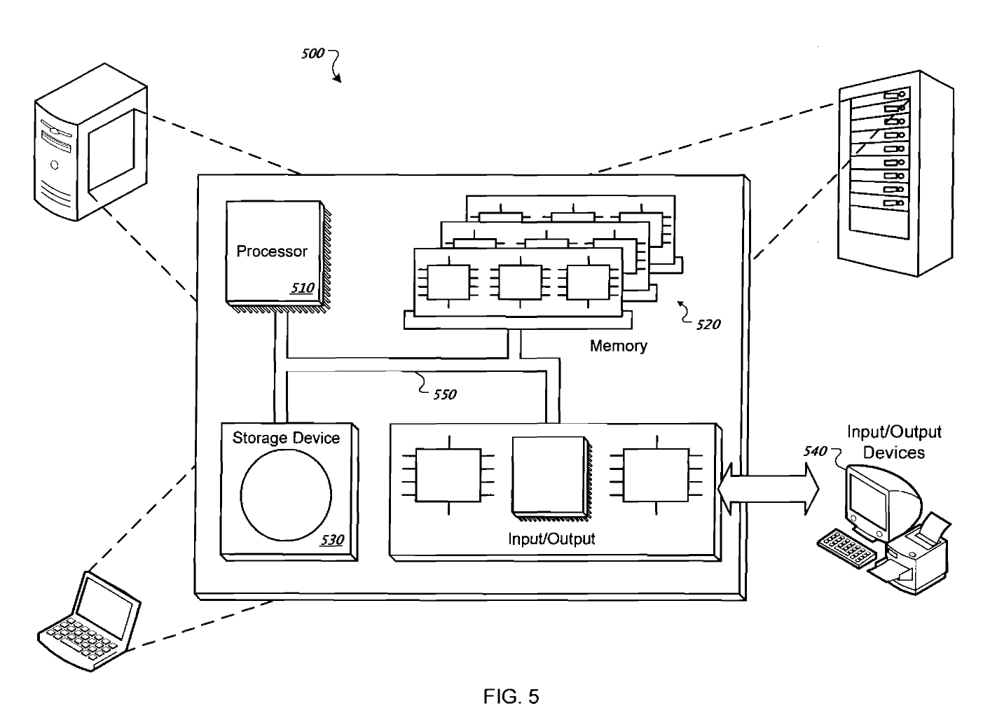

FIG. 5 is a schematic diagram of a generic computer system 500. The system 500 can be used for the operations described in association with any of the computer-implement methods described previously, according to one implementation. The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 may be a floppy disk device, a hard disk device, an optical disk device, or a tape device.

The input/output device 540 provides input/output operations for the system 500. In one implementation, the input/output device 540 includes a keyboard and/or pointing device. In another implementation, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

What is claimed is:

1. A computer-implemented method for providing a model with surface features, the method comprising:
obtaining first and second models of an object, the first model having a first-model resolution that is higher than a resolution of the second model and including surface features, the second model being generated independently of the first model;
generating a version of the first model that has a lower resolution than the first-model resolution;
determining a difference between the second model and the version of the first model; and
modifying the second model to include the surface features, wherein the modification includes compensating for the determined difference.

2. The computer-implemented method of claim 1, wherein the object is a character in an animation.

3. The computer-implemented method of claim 1, wherein the object is a non-character feature in an animation.

4. The computer-implemented method of claim 1, wherein the first model is obtained by scanning a physical object, and wherein the surface features in the first model correspond to physical surface features on the physical object.

5. The computer-implemented method of claim 1, wherein the version of the first model is generated at about the same resolution as the second model.

6. The computer-implemented method of claim 1, wherein an original version of the second model has a different positional configuration than the first model, further comprising reconfiguring the original version of the second model into the second model before the difference is determined, wherein the reconfiguration seeks to eliminate the different positional configuration.

7. The computer-implemented method of claim 1, wherein determining the difference comprises performing a raytracing performed between the second model and the version of the first model.

8. The computer-implemented method of claim 1, wherein the compensation comprises subtracting the difference from a raytracing performed between the first model and the second model.

9. The computer-implemented method of claim 7, wherein determining the difference comprises performing a raytracing performed between the second model and the version of the first model.

10. The computer-implemented method of claim 1, wherein the modification of the second model is performed as part of a rendering operation following an animation.

11. The computer-implemented method of claim 1, wherein modifying the second model comprises applying a texture map corresponding to the surface features, and wherein the compensation is done in generating the texture map.

12. The computer-implemented method of claim 11, further comprising repeating the generating step to generate multiple versions of the first model at different resolutions, and using the multiple versions to generate multiple texture maps.

13. The computer-implemented method of claim 12, wherein at least one of the texture maps is used in the compensation for a specific portion of the second model, and wherein at least another one of the texture maps is used in the compensation for another specific portion of the second model.

14. The computer-implemented method of claim 13, wherein the second model includes a hierarchy of features, and wherein the specific portion and the other specific portion are at different levels of detail in the hierarchy.

15. A computer program product tangibly embodied in an information carrier and comprising instructions that when executed by a processor perform a method for providing a model with surface features, the method comprising:
obtaining first and second models of an object, the first model having a first-model resolution that is higher than a resolution of the second model and including surface features, the second model being generated independently of the first model;
generating a version of the first model that has a lower resolution than the first-model resolution;
determining a difference between the second model and the version of the first model; and
modifying the second model to include the surface features, wherein the modification includes compensating for the determined difference.
